(19) United States
(12) Patent Application Publication
(10) Pub. No.: US 2026/0031270 A1
(43) Pub. Date: Jan. 29, 2026

(54) MAGNETIC COMPONENT

(71) Applicant: Delta Electronics, Inc., Taipei (TW)

(72) Inventors: Boyi Zhang, Durham, NC (US); Ruxi Wang, Durham, NC (US); Peter Mantovanelli Barbosa, Durham, NC (US); Yu-Sheng Chen, Durham, NC (US); Jinfa Zhang, Shanghai (CN)

(21) Appl. No.: 18/781,021

(22) Filed: Jul. 23, 2024

(51) Int. Cl. H01F 27/38; H01F 27/42; H01F 29/14

(52) U.S. Cl. CPC H01F 27/38; H01F 27/427; H01F 29/146

(57) ABSTRACT

A magnetic component is provided. The magnetic component includes a main magnetic core, a main winding, an auxiliary magnetic core and an auxiliary winding. The main magnetic core has a gap. The main winding is wound around the main magnetic core, and a main magnetic flux is formed by a main current flowing through the main winding. The auxiliary magnetic core is at least partially disposed in the gap. The auxiliary winding is wound around the auxiliary magnetic core, a bias magnetic flux is formed by a bias current flowing through the auxiliary winding, and a path of the bias magnetic flux is perpendicular to a path of the main magnetic flux. An inductance of the magnetic component is adjustable by controlling the bias current which determines if the auxiliary magnetic core is at least partially magnetically saturated.

### FIELD OF THE INVENTION

The present disclosure relates to a magnetic component, and more particularly to a magnetic component with an adjustable inductance.

### BACKGROUND OF THE INVENTION

Usually, changing the inductance value of magnetic components is desired to adapt to different operating conditions or requirements. One common reason is frequency tuning, as the inductance value affects the circuit's resonance frequency, the optimization for different frequencies may be realized through adjusting the inductance value. Additionally, adjusting the inductance value can facilitate the impedance matching which is crucial for maximum power transfer or efficiency. Moreover, adjusting the inductance value can be used to control the circuit energy consumption for meeting energy-saving or power requirements. Furthermore, inductors are also commonly used for voltage stabilization and filtering in circuits, and thus adjusting the inductance value may regulate the effect of stabilization and filtering to adapt to various operating conditions or requirements.

Conventionally, the adjustment for inductance may be achieved by altering the material, size, or structure of the magnetic component. However, physically changing the structure of magnetic components is difficult, and thus many researchers look to use current to control the inductance. In many cases, as shown in FIG. 1, an auxiliary winding 100 is added on the same magnetic core as the main winding 200. The magnetic flux generated by the auxiliary winding 100 shares part of the path with the magnetic flux generated by the main winding 200. Accordingly, when a bias current flows through the auxiliary winding 100, part of the magnetic core operates at a different point on the B-H curve (a hysteresis curve reflecting the relation between the magnetic flux density and the magnetic field intensity).

Therefore, there is a need of providing a magnetic component in order to overcome the drawbacks of the conventional technologies.

### SUMMARY OF THE INVENTION

The present disclosure provides a magnetic component with an adjustable inductance. Along the path of the main magnetic flux, part of the path is filled with the auxiliary magnetic core that can be at least partially magnetically saturated. Accordingly, an inductance of the magnetic component is adjustable by controlling the bias current which determines if the auxiliary magnetic core is at least partially magnetically saturated. Further, a path of the bias magnetic flux generated by the bias current flowing through the auxiliary magnetic core is perpendicular to the path of the main magnetic flux. Consequently, the operation point of the main magnetic flux on the B-H curve would not be affected by the bias magnetic flux.

In accordance with an aspect of the present disclosure, a magnetic component is provided. The magnetic component includes a main magnetic core, a main winding, an auxiliary magnetic core and an auxiliary winding. The main magnetic core has a gap. The main winding is wound around the main magnetic core, and a main magnetic flux is formed by a main current flowing through the main winding. The auxiliary magnetic core is at least partially disposed in the gap. The auxiliary winding is wound around the auxiliary magnetic core, a bias magnetic flux is formed by a bias current flowing through the auxiliary winding, and a path of the bias magnetic flux is perpendicular to a path of the main magnetic flux. An inductance of the magnetic component is adjustable by controlling the bias current which determines if the auxiliary magnetic core is at least partially magnetically saturated.

### BRIEF DESCRIPTION OF THE DRAWINGS

FIG. 1 schematically shows a conventional magnetic component;

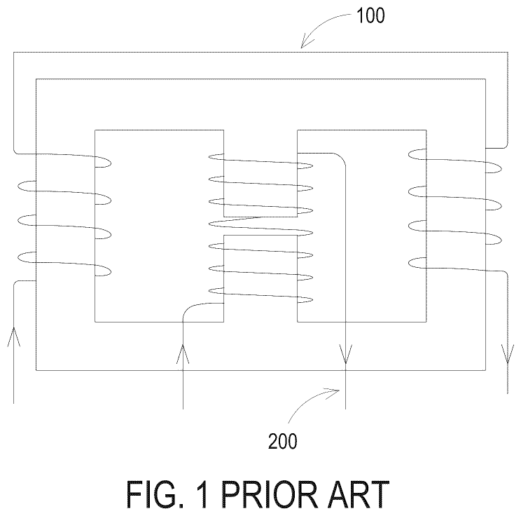

FIG. 2 is a schematic cross-section view illustrating a magnetic component according to a first embodiment of the present disclosure;

FIG. 3 is a schematic cross-section view illustrating a magnetic component according to a second embodiment of the present disclosure;

FIG. 4A is a schematic perspective view illustrating a magnetic component according to a third embodiment of the present disclosure;

FIG. 4B is a schematic exploded view of the magnetic component of FIG. 4A;

FIG. 5 is a schematic perspective view illustrating a magnetic component according to a fourth embodiment of the present disclosure;

FIG. 6A is a schematic perspective view illustrating a magnetic component according to a fifth embodiment of the present disclosure;

FIG. 6B is a schematic front view of the magnetic component of FIG. 6A;

FIG. 7 is a schematic exploded view illustrating a magnetic component according to a sixth embodiment of the present disclosure;

FIG. 8 schematically shows a variant of the magnetic component of FIG. 7;

FIG. 9 is a schematic exploded view illustrating a magnetic component according to a seventh embodiment of the present disclosure;

FIG. 10 is a schematic exploded view illustrating a magnetic component according to an eighth embodiment of the present disclosure;

FIG. 11 schematically shows a variant of the magnetic component of FIG. 10 that the auxiliary magnetic core and the auxiliary winding are embedded in a printed circuit board;

FIG. 12 schematically shows a variant of the magnetic component of FIG. 10 that the main winding units, the auxiliary magnetic core and the auxiliary winding are embedded in a printed circuit board;

FIG. 13 schematically shows relation curves of efficiency and input power of a power converter with different inductors having different inductance values; and

FIG. 14 schematically shows relation curves of efficiency and input power of a power converter with different inductors having different inductance values and an inductor having variable inductance value.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

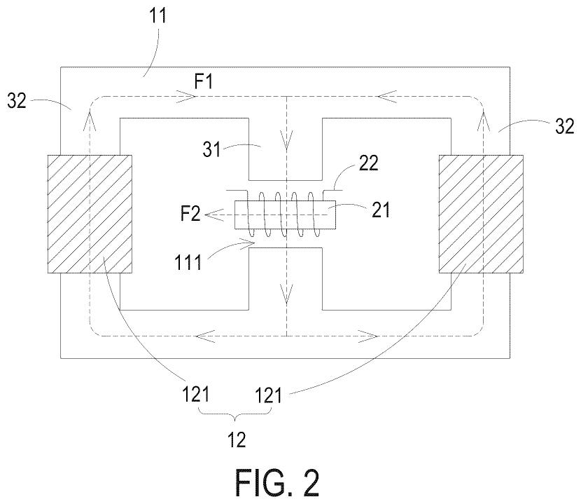

FIG. 2 is a schematic cross-section view illustrating a magnetic component according to a first embodiment of the present disclosure. As shown in FIG. 2, the magnetic component 1 includes a main magnetic core 11, a main winding 12, an auxiliary magnetic core 21, and an auxiliary winding 22. The main magnetic core 11 has a gap 111. The main winding 12 is wound around the main magnetic core 11, and a main magnetic flux F1 is formed by a main current flowing through the main winding 12. The auxiliary magnetic core 21 is at least partially disposed in the gap 111. The auxiliary winding 22 is wound around the auxiliary magnetic core 21, and a bias magnetic flux F2 is formed by a bias current flowing through the auxiliary winding 22. The main winding 12 and the auxiliary winding 22 can be any suitable winding such as PCB (printed circuit board) winding, Litz wire winding or copper wire winding and are not limited to the type shown in the figure. The path of the bias magnetic flux F2 is perpendicular to a path of the main magnetic flux F1, thereby preventing the main magnetic flux F1 and bias magnetic flux F2 from affecting each other. It is noted that the directions of the main magnetic flux F1 and the bias magnetic flux F2 are shown in the figure as an example, but not limited thereto, and the directions of magnetic fluxes depend on the flowing directions of the currents of windings. However, no matter what the directions of magnetic fluxes are, the path of the bias magnetic flux F2 would be perpendicular to a path of the main magnetic flux F1.

The inductance of the magnetic component 1 is adjustable by controlling the bias current which determines if the auxiliary magnetic core 21 is at least partially magnetically saturated. In specific, when a circuit including the magnetic component 1 is operating, the main current flows through the main winding 12 and generates the main magnetic flux F1. If the bias current is turned on, the bias current flows through the auxiliary winding 22 and generates the bias magnetic flux, which makes the auxiliary magnetic core 21 at least partially magnetically saturated. Since the auxiliary magnetic core 21 is at least partially disposed in the gap 111 of the main magnetic core 11, the magnetic saturation of the auxiliary magnetic core 21 increases the reluctance of the main magnetic core 11, thereby reducing the inductance of the magnetic component 1. Consequently, the inductance of the magnetic component 1 may be reduced by controlling the bias current to make the auxiliary magnetic core 21 at least partially magnetically saturated. In addition, since the main magnetic flux F1 and the bias magnetic flux F2 would not affect each other, the main magnetic core 11 still operates at its original operation point on the B-H curve when the auxiliary magnetic core 21 is at least partially magnetically saturated by the bias current.

In an embodiment, the bias current is a switched current source which provides one or multiple levels of DC current. Further, the bias current is independently controlled, and the bias magnetic flux F2 doesn't interfere with the main magnetic flux F1. If the bias current is the switched current source providing one level of DC current, the bias current may be turned on or off to make the auxiliary magnetic core 21 magnetically saturated or not. Alternatively, if the bias current is the switched current source providing multiple levels of DC current, the magnetic saturation level of the auxiliary magnetic core 21 may be controlled through switching the level of DC current of the bias current.

In addition, in the magnetic component 1 of FIG. 2, the main magnetic core 11 includes a center pillar 31, two side pillars 32 located at two sides of the center pillar 31 respectively, and a gap 111 on the center pillar 31. The main winding 12 includes two main winding units 121 wound around the two side pillars 32 respectively, and the two main winding units 121 may be regarded as two forming parts of the main winding 12. The auxiliary winding 22 is wound around the part of auxiliary magnetic core 21 accommodated in the gap 111. It is noted that the number and position of the gap and the forming parts of windings are not limited and can be adjusted according to actual requirements. Also, the specific shape and structure of the main magnetic core 11 and auxiliary magnetic core 21 are not limited and can be adjusted according to actual requirements. Various kinds of implementations of the magnetic component of the present disclosure would be exemplified in following embodiments, while it should be noted that the magnetic component of the present disclosure is not limited to these implementations.

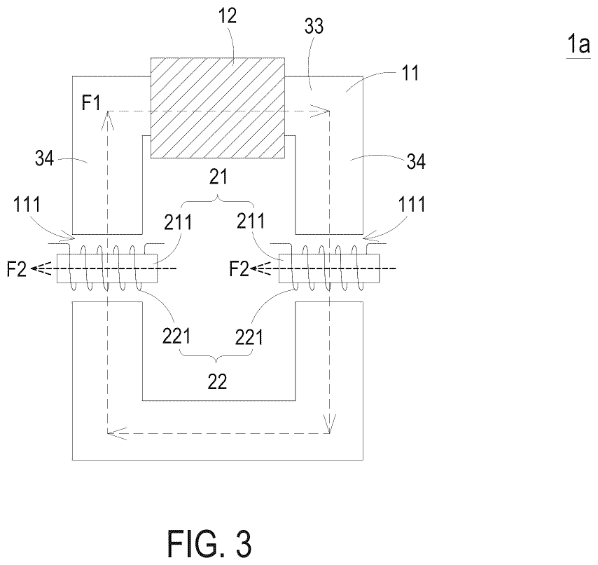

FIG. 3 is a schematic cross-section view illustrating a magnetic component according to a second embodiment of the present disclosure. In FIG. 3, the component parts and elements corresponding to those of FIG. 2 are designated by identical numeral references, and detailed descriptions thereof are omitted herein. As shown in FIG. 3, in the magnetic component 1a of this embodiment, the main magnetic core 11 includes a top pillar 33, two side pillars 34 coupled to two terminals of the top pillar 33 respectively, and two gaps 111 on the two side pillars 34 respectively. The main winding 12 is wound around the top pillar 33. The auxiliary magnetic core 21 includes two auxiliary magnetic core units 211 which are at least partially disposed in the two gaps 111 respectively, and the two auxiliary magnetic core units 211 may be regarded as two forming parts of the auxiliary magnetic core 21. The auxiliary winding 22 includes two auxiliary winding units 221 wound around the two auxiliary magnetic core units 211 respectively, and the two auxiliary winding units 221 may be regarded as two forming parts of the auxiliary winding 22. Under the circumstance that the magnetic component 1a includes a plurality of auxiliary magnetic core units 211 and a plurality of auxiliary winding units 221, a plurality of bias currents flow through the plurality of auxiliary winding units 221, and each bias current determines if the corresponding auxiliary magnetic core unit 211 is at least partially magnetically saturated. The plurality of bias currents may be identical or different.

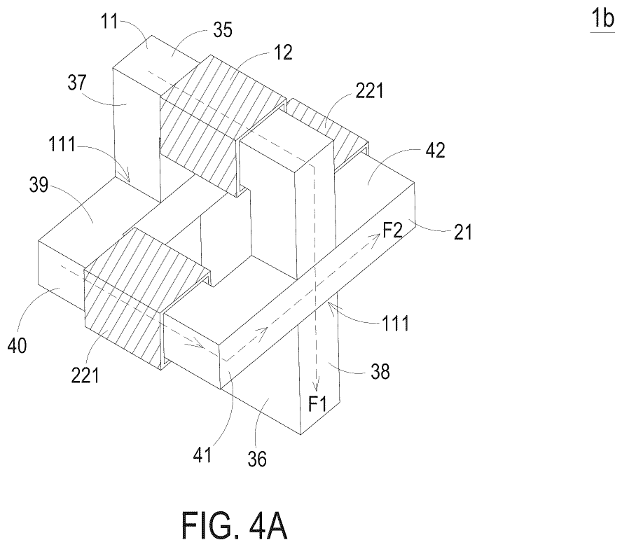

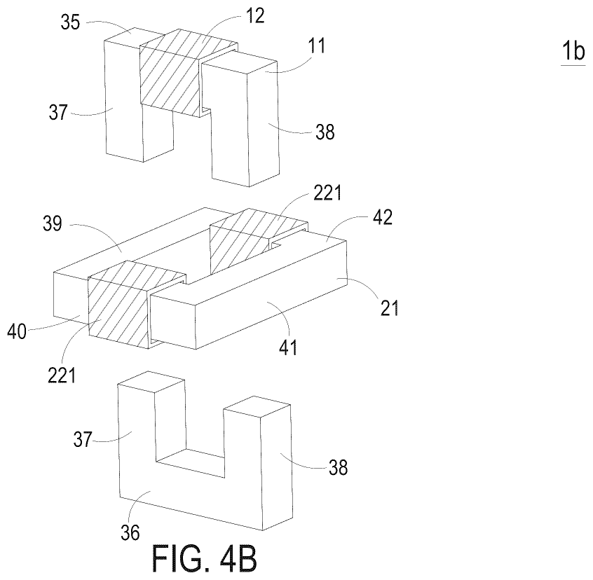

FIG. 4A is a schematic perspective view illustrating a magnetic component according to a third embodiment of the present disclosure, and FIG. 4B is a schematic exploded view of the magnetic component of FIG. 4A. In FIG. 4A and FIG. 4B, the component parts and elements corresponding to those of FIG. 3 are designated by identical numeral references, and detailed descriptions thereof are omitted herein. As shown in FIG. 4A and FIG. 4B, in the magnetic component 1b, the main magnetic core 11 may be formed by two U-type cores, and includes a top pillar 35, a bottom pillar 36, two side pillars 37 and 38, and two gaps 111. The bottom pillar 36 is opposite to the top pillar 35, the two side pillars 37 and 38 are opposite to each other and are coupled between the top pillar 35 and the bottom pillar 36, and the two gaps 111 are on the two side pillars 37 and 38 respectively. The main winding 12 is wound around the top pillar 35. The auxiliary magnetic core 21 may have a ring shape, such as a rectangular-frame shape or an elliptic-frame shape (e.g., formed by two U-type cores), and the plane in which the auxiliary magnetic core 21 is located is perpendicular to the plane in which the main magnetic core 11 is located. The auxiliary magnetic core 21 has a first side 39, a second side 40, a third side 41, and a fourth side 42. The first side 39 is opposite to the third side 41, and the second side 40 is opposite to the fourth side 42. A part of the first side 39 is accommodated in the gap 111 on the side pillar 37, and a part of the third side 41 is accommodated in the gap 111 on the side pillar 38. The auxiliary winding 22 includes two auxiliary winding units 221 wound around the second side 40 and the fourth side 42 of the auxiliary magnetic core 21 respectively. In this embodiment, as the bias current is provided to generate the bias magnetic flux, the parts of the first side 39 and third side 41 accommodated in the gaps 111 are saturated to change the reluctance of the main magnetic core 11, and hence the inductance changes. In an embodiment, the two auxiliary winding units 221 are evenly and symmetrically distributed on the second side 40 and the fourth side 42 of the auxiliary magnetic core 21 with reference to the main magnetic core 11. Besides, two winding axes of the two auxiliary winding units 221 are in the plane in which the auxiliary magnetic core 21 is located. The plane in which the winding axes of the two auxiliary winding units 221 are located is perpendicular to the plane in which axes of the top pillar 35, the bottom pillar 36 and the two side pillars 37 and 38 of the main magnetic core 11 are located.

In addition, in an embodiment, the part of the first side 39 accommodated in the gap 111 is at the middle of the first side 39, and the part of the third side 41 accommodated in the gap 111 is at the middle of the third side 41. Accordingly, the structure of the auxiliary magnetic core 21 is symmetrical with reference to the main magnetic core 11. Further, the fluxes generated by the two auxiliary winding units 221 cancel each other out in the main magnetic core 11, and the main magnetic core 11 operates at zero bias.

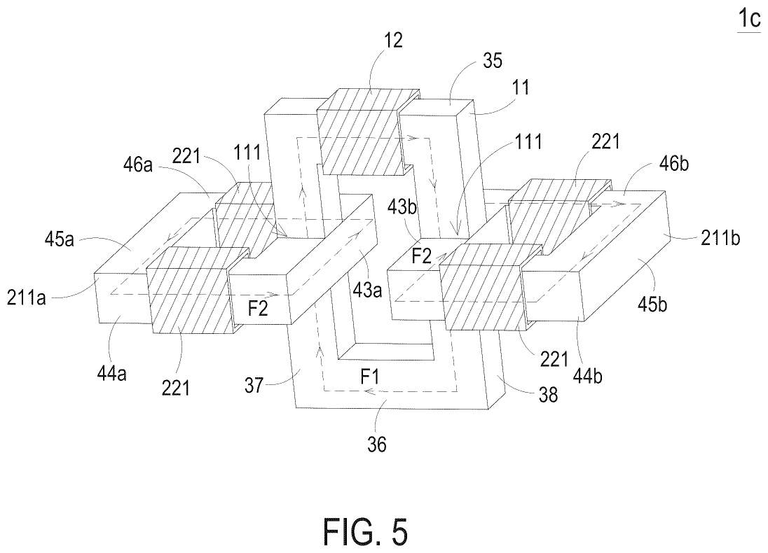

FIG. 5 is a schematic perspective view illustrating a magnetic component according to a fourth embodiment of the present disclosure. In FIG. 5, the component parts and elements corresponding to those of FIG. 4A are designated by identical numeral references, and detailed descriptions thereof are omitted herein. The difference between the magnetic component 1b of FIG. 4A and the magnetic component 1c of FIG. 5 lies in the auxiliary magnetic core and auxiliary winding. As shown in FIG. 5, in the magnetic component 1c of this embodiment, the auxiliary magnetic core 21 includes a first auxiliary magnetic core unit 211a and a second auxiliary magnetic core unit 211b at least partially disposed in the two gaps on the two side pillars 37 and 38 respectively, and the auxiliary winding 22 includes four auxiliary winding units 221. In specific, the first auxiliary magnetic core unit 211a has a ring shape and has a first side 43a, a second side 44a, a third side 45a, and a fourth side 46a. The first side 43a is opposite to the third side 45a, and the second side 44a is opposite to the fourth side 46a. A part of the first side 43a is accommodated in the gap 111 on the side pillar 37, and two auxiliary winding units 221 are wound around the second side 44a and the fourth side 46a of the first auxiliary magnetic core unit 211a respectively. Similarly, the second auxiliary magnetic core unit 211b has a ring shape and has a first side 43b, a second side 44b, a third side 45b, and a fourth side 46b. The first side 43b is opposite to the third side 45b, and the second side 44b is opposite to the fourth side 46b. A part of the first side 43b is accommodated in the gap 111 on the side pillar 38, and two auxiliary winding units 221 are wound around the second side 44b and the fourth side 46b of the second auxiliary magnetic core unit 211b respectively. In this embodiment, the path of the bias magnetic flux F2 and the path of the main magnetic flux F1 are fully decoupled. Further, the first and second auxiliary magnetic core units 211a and 211b may be excited simultaneously or individually. In an embodiment, the first and second auxiliary magnetic core units 211a and 211b are located in the same plane, which is perpendicular to the plane in which the main magnetic core 11 is located. More specifically, the plane in which winding axes of the four auxiliary winding units 221 are located is perpendicular to a plane in which axes of the top pillar 35, the bottom pillar 36 and the two side pillars 37 and 38 of the main magnetic core 11 are located.

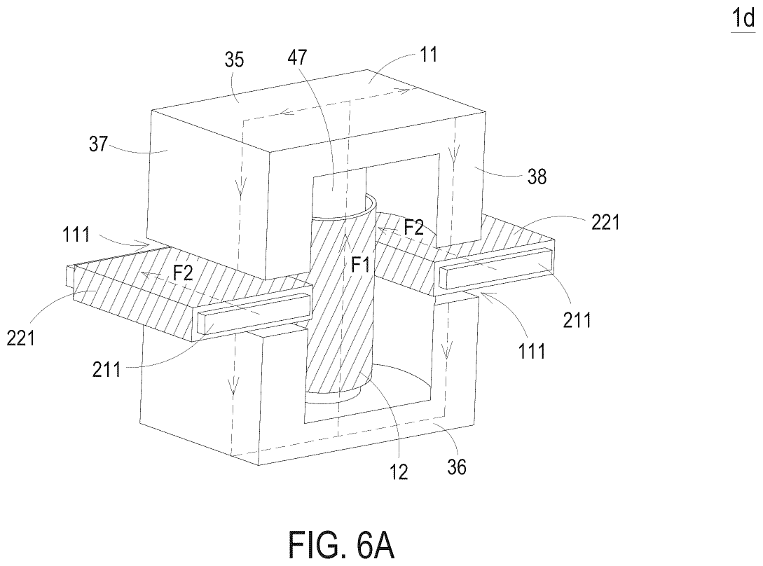

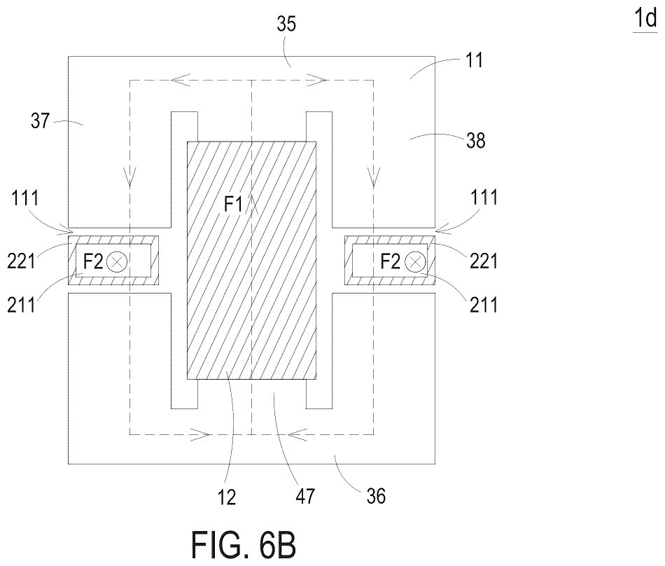

FIG. 6A is a schematic perspective view illustrating a magnetic component according to a fifth embodiment of the present disclosure, and FIG. 6B is a schematic front view of the magnetic component of FIG. 6A. In FIG. 6A and FIG. 6B, the component parts and elements corresponding to those of FIG. 4A are designated by identical numeral references, and detailed descriptions thereof are omitted herein. As shown in FIG. 6A and FIG. 6B, in the magnetic component 1d of this embodiment, the main magnetic core 11 may be formed by two E-type cores, and includes a top pillar 35, a bottom pillar 36, two side pillars 37 and 38, a center pillar 47, and two gaps 111. The center pillar 47 is disposed between the two side pillars 37 and 38, and two ends of the center pillar 47 is coupled to the top pillar 35 and the bottom pillar 36 respectively. The main winding 12 is wound around the center pillar 47. Two auxiliary magnetic core units 211 are at least partially accommodated in the two gaps 111 on the two side pillars 37 and 38 respectively, and the two auxiliary winding units 221 are at least partially wound around the parts of the two auxiliary magnetic core units 211 accommodated in the two gaps 111 respectively.

In addition, in the magnetic component of the present disclosure, the plurality of auxiliary magnetic core units of the auxiliary magnetic core may have different magnetic permeabilities and different saturation magnetic flux densities (e.g., be made of different materials like ferrite and nanocrystalline). This concept may be applied to any embodiment of the present disclosure. For ease of understanding, a few possible implementations are shown as follows based on the embodiment of FIG. 4A and FIG. 4B.

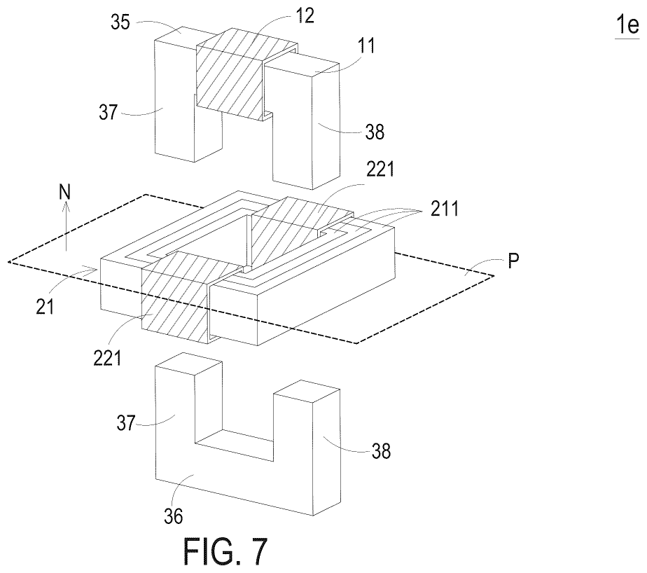

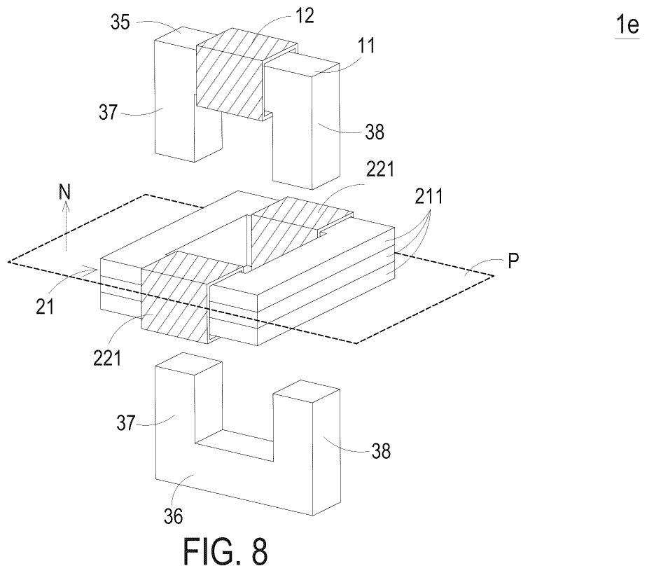

FIG. 7 is a schematic exploded view illustrating a magnetic component according to a sixth embodiment of the present disclosure. In FIG. 7, the component parts and elements corresponding to those of FIG. 4B are designated by identical numeral references, and detailed descriptions thereof are omitted herein. As shown in FIG. 7, in the magnetic component 1e of this embodiment, the auxiliary magnetic core 21 includes a plurality of auxiliary magnetic core units 211 arranged along a direction perpendicular to a normal line N of a plane P in which the auxiliary magnetic core 21 is located. The auxiliary winding units 221 are wound around two sides of the auxiliary magnetic core 21 respectively, and each auxiliary winding unit 221 is wound around the plurality of auxiliary magnetic core units 211. In a variant of the sixth embodiment of FIG. 7, the plurality of auxiliary magnetic core units 211 may be arranged along a direction parallel to the normal line N of the plane P in which the auxiliary magnetic core 21 is located, as shown in FIG. 8.

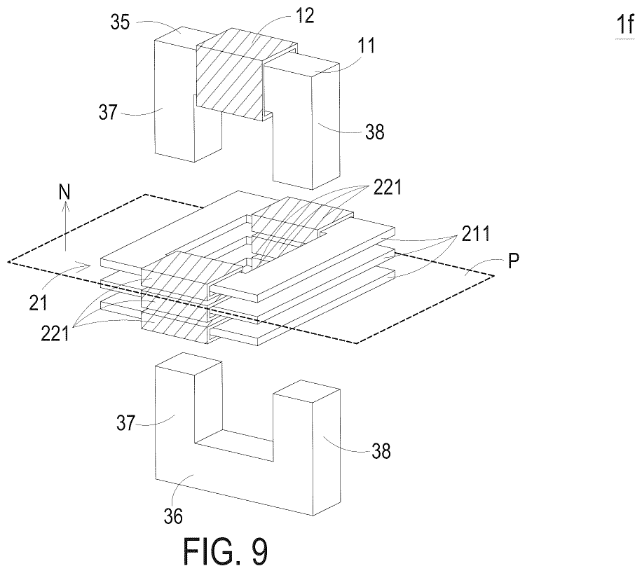

FIG. 9 is a schematic exploded view illustrating a magnetic component according to a seventh embodiment of the present disclosure. In FIG. 9, the component parts and elements corresponding to those of FIG. 7 are designated by identical numeral references, and detailed descriptions thereof are omitted herein. As shown in FIG. 9, in the magnetic component 1f of this embodiment, the auxiliary magnetic core 21 includes a plurality of auxiliary magnetic core units 211 arranged along a direction parallel to the normal line N of the plane P in which the auxiliary magnetic core 21 is located. The auxiliary winding 22 includes a plurality of auxiliary winding units 221 wound around the plurality of auxiliary magnetic core units 211 respectively. In specific, at each side of the auxiliary magnetic core 21 wound by the auxiliary winding, three auxiliary winding units 221 are wound around the three auxiliary magnetic core units 211 respectively. Similarly, the concept of dividing the auxiliary winding into plural units may be applied to the embodiment of FIG. 7, and detailed descriptions are omitted herein.

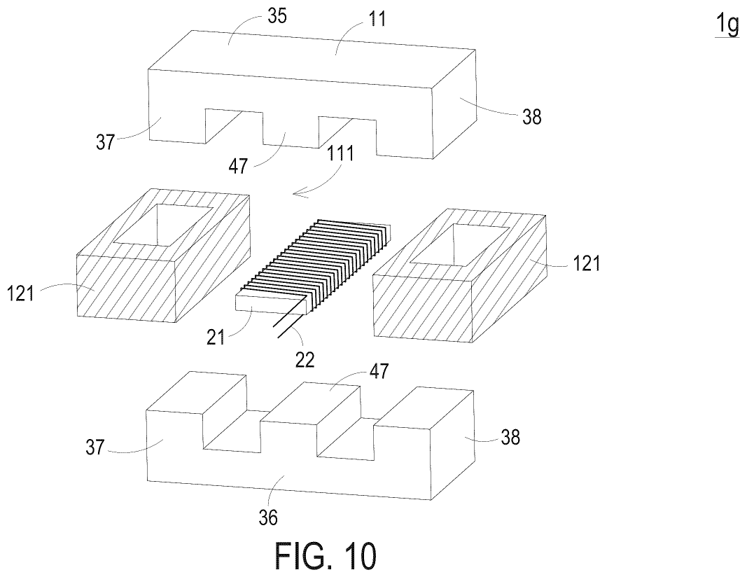

FIG. 10 is a schematic exploded view illustrating a magnetic component according to an eighth embodiment of the present disclosure. In FIG. 10, the component parts and elements corresponding to those of FIG. 6A and FIG. 6B are designated by identical numeral references, and detailed descriptions thereof are omitted herein. As shown in FIG. 10, in the magnetic component 1g of this embodiment, the main winding 12 includes two main winding units 121 wound around the two side pillars 37 and 38 of the main magnetic core 11 respectively. The gap 111 is on the center pillar 47, and the auxiliary winding 22 is wound around the auxiliary magnetic core 21 which is at least partially disposed in the gap 111.

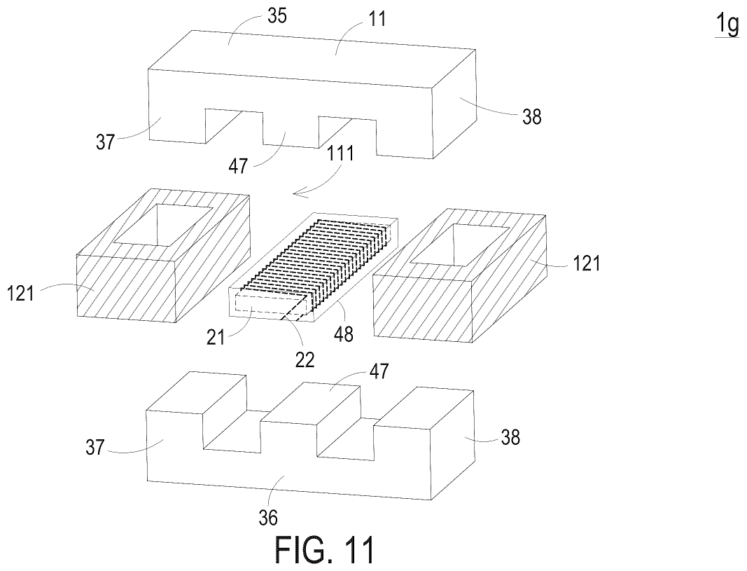

In an embodiment, the auxiliary magnetic core 21 and the auxiliary winding 22 of the magnetic component 1g may be embedded in a printed circuit board 48, as shown in FIG. 11. In particular, the auxiliary magnetic core 21 is embedded inside the printed circuit board 48, and the auxiliary winding 22 is designed with traces of the printed circuit board 48. It is noted that the magnetic component 1g of this embodiment forms a transformer, and the middle leg reluctance controls the leakage inductance of the transformer.

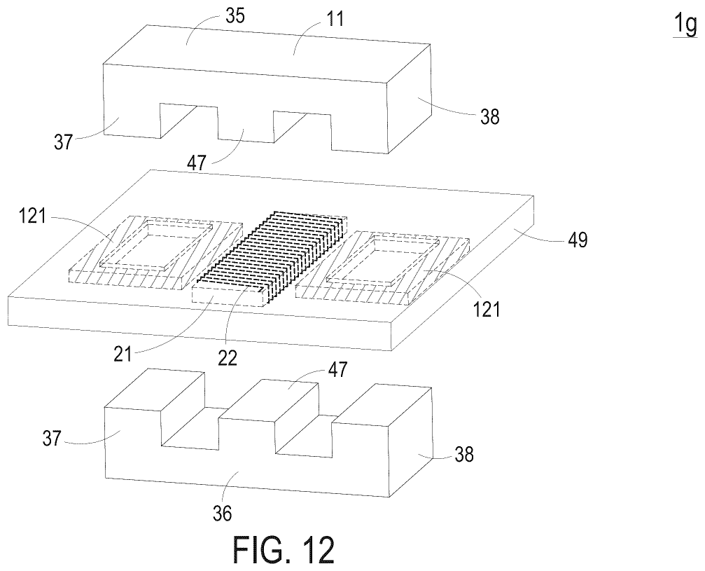

In an embodiment, the two main winding units 121, the auxiliary magnetic core 21 and the auxiliary winding 22 of the magnetic component 1g may be embedded in a printed circuit board 49, as shown in FIG. 12. In particular, the auxiliary magnetic core 21 is embedded inside the printed circuit board 49, and the main winding units 121 and the auxiliary winding 22 are designed with traces of the printed circuit board 49.

Actually, the element of the magnetic component embedded in the printed circuit board is not limited and may be adjusted according to actual structure and requirements. In an embodiment, at least one of the main magnetic core, the main winding, the auxiliary magnetic core and the auxiliary winding is embedded in the printed circuit board.

In the magnetic component of the present disclosure, the relation between the bias current, the number of turns of auxiliary winding, the saturation magnetic flux density of the auxiliary magnetic core and the effective length of the auxiliary magnetic core is shown in equation (1).

$${N}_{b i a s} \cdot {I}_{b i a s} = \frac{{B}_{s a t}}{{μ}_{i} {μ}_{r}} \cdot {l}_{eff} \qquad ( 1 )$$

N_{bias} is the number of turns of auxiliary winding, I_{bias} is the bias current, Bₛₐₜ is the saturation magnetic flux density of the auxiliary magnetic core, and l_{eff} is the effective length of the auxiliary magnetic core. The DC power loss in the auxiliary winding can be acquired through equation (2).

$$\begin{matrix}{P}_{D C} = {I}_{b i a s}^{2} \cdot {R}_{a u x} \\ {R}_{a u x} = \frac{4 ρ {l}_{a u x} {N}_{b i a s}}{π {d}^{2}}\end{matrix} \qquad ( 2 )$$

P_{DC} is the DC power loss, Rₐᵤₓ is the resistance of the auxiliary winding, ρ is the resistivity of the winding material, lₐᵤₓ is the length of a single turn of the auxiliary winding, and d is the wire gauge of the auxiliary winding. Equation (3) is obtained by combining equations (1) and (2).

$${P}_{D C} = 4 \cdot \frac{{B}_{s a t}}{{N}_{b i a s} {μ}_{i} {μ}_{r}} \cdot {l}_{eff} \cdot \frac{ρ {l}_{a u x}}{π {d}^{2}} \qquad ( 3 )$$

According to equation (3), in order to reduce the DC power loss, the number of turns of auxiliary winding should be as much as possible. In addition, tradeoff needs to be made to make one design with acceptable power loss and wire gauge.

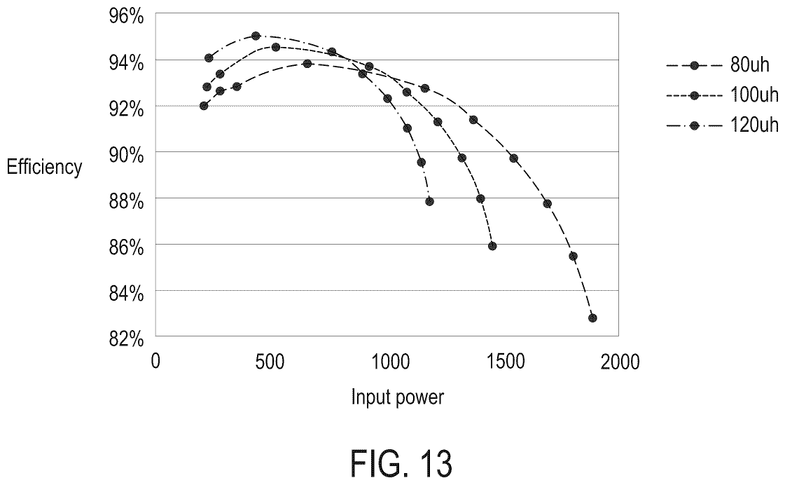

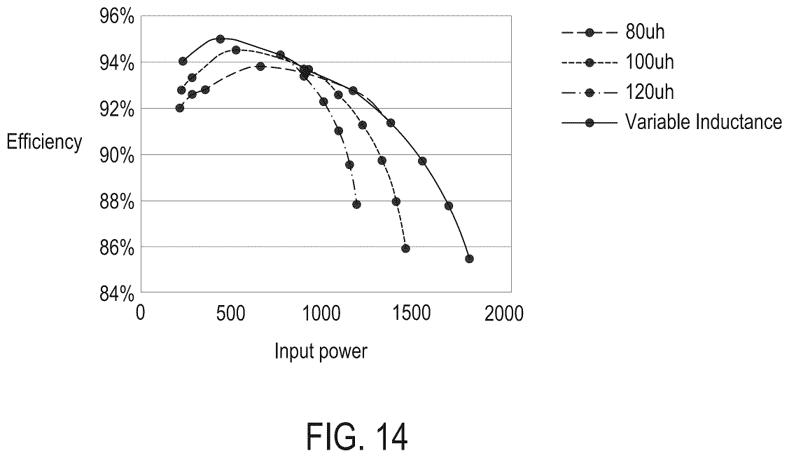

FIG. 13 schematically shows relation curves of efficiency and input power of a power converter with different inductors having different inductance values. As shown in FIG. 13, under different input powers, the inductance allowing the power converter to have the best efficiency are different. Therefore, for the conventional power converter with the inductor having fixed inductance value, the power converter is unable to achieve the best efficiency under different input powers. Further, the inductance value of the inductor may also affect the range of input power. The magnetic component of the present disclosure allows the power converter to have an inductor with variable inductance value. Thereby, as shown in FIG. 14, with the variable inductance value, the power converter can always have the best efficiency under different input powers, and also the range of input power is increased.

In summary, the present disclosure provides a magnetic component with an adjustable inductance. Along the path of the main magnetic flux, part of the path is filled with the auxiliary magnetic core that can be at least partially magnetically saturated. Accordingly, an inductance of the magnetic component is adjustable by controlling the bias current which determines if the auxiliary magnetic core is at least partially magnetically saturated. Further, a path of the bias magnetic flux generated by the bias current flowing through the auxiliary magnetic core is perpendicular to the path of the main magnetic flux. Consequently, the operation point of the main magnetic flux on the B-H curve would not be affected by the bias magnetic flux, and the B-H curve can be fully used. Further, the effect of adjustable inductance allows the power converter employing the magnetic component of the present disclosure to have wider range of input power and to have best efficiency under different input powers.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic component, comprising:
a main magnetic core, having a gap;
a main winding, wound around the main magnetic core, wherein a main magnetic flux is formed by a main current flowing through the main winding;
an auxiliary magnetic core, at least partially disposed in the gap; and
an auxiliary winding, wound around the auxiliary magnetic core, wherein a bias magnetic flux is formed by a bias current flowing through the auxiliary winding, and a path of the bias magnetic flux is perpendicular to a path of the main magnetic flux,
wherein an inductance of the magnetic component is adjustable by controlling the bias current which determines if the auxiliary magnetic core is at least partially magnetically saturated.

2. The magnetic component according to claim 1, wherein the inductance of the magnetic component is reduced by controlling the bias current to make the auxiliary magnetic core at least partially magnetically saturated.

3. The magnetic component according to claim 1, wherein the bias current is a switched current source which provides one or multiple levels of DC current.

4. The magnetic component according to claim 1, wherein the bias current is independently controlled, and the bias magnetic flux does not interfere with the main magnetic flux.

5. The magnetic component according to claim 1, wherein a structure of the auxiliary magnetic core is symmetrical with reference to the main magnetic core.

6. The magnetic component according to claim 1, wherein the auxiliary magnetic core has two sides, the auxiliary winding comprises a plurality of auxiliary winding units which are evenly and symmetrically distributed on the two sides of the auxiliary magnetic core with reference to the main magnetic core.

7. The magnetic component according to claim 6, wherein fluxes generated by the plurality of auxiliary winding units cancel each other out in the main magnetic core, and the main magnetic core operates at zero bias.

8. The magnetic component according to claim 1, wherein the path of the bias magnetic flux and the path of the main magnetic flux are fully decoupled.

9. The magnetic component according to claim 1, wherein the main magnetic core comprises a center pillar and a plurality of side pillars, the gap is on the center pillar, and the main winding comprises a plurality of main winding units wound around the plurality of side pillars respectively.

10. The magnetic component according to claim 1, wherein the main magnetic core has a plurality of said gaps, the auxiliary magnetic core comprises a plurality of auxiliary magnetic core units each at least partially disposed in a corresponding one of the plurality of gaps, and the auxiliary winding comprises a plurality of auxiliary winding units wound around the plurality of auxiliary magnetic core units respectively.

11. The magnetic component according to claim 10, wherein the main magnetic core comprises a top pillar, a bottom pillar and a plurality of side pillars coupled between the top pillar and the bottom pillar, the plurality of gaps are on the plurality of side pillars respectively, and the main winding is wound around the top pillar.

12. The magnetic component according to claim 10, wherein a plurality of bias currents flow through the plurality of auxiliary winding units respectively, and each of the plurality of bias currents determines if a corresponding one of the plurality of auxiliary magnetic core units is at least partially magnetically saturated.

13. The magnetic component according to claim 12, wherein the plurality of bias currents are identical.

14. The magnetic component according to claim 12, wherein the plurality of bias currents are different.

15. The magnetic component according to claim 1, wherein the auxiliary magnetic core comprises a plurality of auxiliary magnetic core units with different magnetic permeabilities and different saturation magnetic flux densities.

16. The magnetic component according to claim 15, wherein the plurality of auxiliary magnetic core units are arranged along a direction parallel to a normal line of a plane in which the auxiliary magnetic core is located.

17. The magnetic component according to claim 15, wherein the plurality of auxiliary magnetic core units are arranged along a direction perpendicular to a normal line of a plane in which the auxiliary magnetic core is located.

18. The magnetic component according to claim 15, wherein the auxiliary winding comprises a plurality of auxiliary winding units wound around the plurality of auxiliary magnetic core units respectively.

19. The magnetic component according to claim 15, wherein the auxiliary winding is wound around the plurality of auxiliary magnetic core units.

20. The magnetic component according to claim 1, further comprising a printed circuit board, wherein at least one of the main magnetic core, the main winding, the auxiliary magnetic core, and the auxiliary winding is embedded in the printed circuit board.

21. The magnetic component according to claim 1, wherein the auxiliary magnetic core is made of at least one of ferrite and nanocrystalline.

22. The magnetic component according to claim 1, wherein the main magnetic core comprises a top pillar, a bottom pillar, and a first side pillar and a second side pillar coupled between the top pillar and the bottom pillar, the main magnetic core has two said gaps on the first and second side pillars respectively, and the main winding is wound around the top pillar.

23. The magnetic component according to claim 22, wherein the auxiliary magnetic core has a first side, a second side, a third side, and a fourth side, the first side is opposite to the third side, the second side is opposite to the fourth side, a part of the first side is accommodated in the gap on the first side pillar of the main magnetic core, a part of the third side is accommodated in the gap on the second side pillar of the main magnetic core, the auxiliary winding comprises two auxiliary winding units wound around the second side and the fourth side respectively, and a plane in which winding axes of the two auxiliary winding units are located is perpendicular to a plane in which axes of the top pillar, the bottom pillar, the first side pillar, and the second side pillar of the main magnetic core are located.

24. The magnetic component according to claim 22, wherein the auxiliary magnetic core comprises a first auxiliary magnetic core unit and a second auxiliary magnetic core unit at least partially disposed in the two gaps on the first and second side pillars respectively, the first auxiliary magnetic core unit has a first side, a second side, a third side, and a fourth side, the first side is opposite to the third side, the second side is opposite to the fourth side, a part of the first side is accommodated in the gap on the first side pillar of the main magnetic core, the auxiliary winding comprises two auxiliary winding units wound around the second side and the fourth side of the first auxiliary magnetic core unit respectively, the second auxiliary magnetic core unit has a fifth side, a sixth side, a seventh side and a eighth side, the fifth side is opposite to the seventh side, the sixth side is opposite to the eighth side, a part of the fifth side is accommodated in the gap on the second side pillar of the main magnetic core, and the auxiliary winding comprises another two auxiliary winding units wound around the sixth side and the eighth side respectively of the second auxiliary magnetic core unit.

25. The magnetic component according to claim 24, wherein a plane in which winding axes of all the auxiliary winding units are located is perpendicular to a plane in which axes of the top pillar, the bottom pillar, the first side pillar, and the second side pillar of the main magnetic core are located.

26. The magnetic component according to claim 1, wherein the main magnetic core comprises a top pillar, a bottom pillar, a center pillar and two side pillars, the center pillar and the two side pillars are coupled between the top pillar and the bottom pillar, the center pillar is located between the two side pillars, the main magnetic core has two said gaps on the two side pillars respectively, the main winding is wound around the center pillar, the auxiliary magnetic core comprises two auxiliary magnetic core units at least partially disposed in the gaps respectively, and the auxiliary winding comprises two auxiliary winding units wound around the two auxiliary magnetic core units respectively.
